(19) United States
(12) Patent Application Publication
(10) Pub. No.: US 2013/0212594 A1
(43) Pub. Date: Aug. 15, 2013

(54) METHOD OF OPTIMIZING PERFORMANCE OF HIERARCHICAL MULTI-CORE PROCESSOR AND MULTI-CORE PROCESSOR SYSTEM FOR PERFORMING THE METHOD

(71) Applicants: Min Seok CHOI, Daejeon (KR); Nak Woong Eum, Daejeon (KR)

(72) Inventors: Min Seok CHOI, Daejeon (KR); Nak Woong Eum, Daejeon (KR)

(73) Assignee: ELECTRONICS AND TELECOMMUNICATIONS RESEARCH INSTITUTE, Daejeon (KR)

(21) Appl. No.: 13/617,294

(22) Filed: Sep. 14, 2012

(30) Foreign Application Priority Data
Feb. 15, 2012 (KR) 10-2012-0015291

(51) Int. Cl. G06F 9/50

(52) U.S. Cl. 718/104

(57) ABSTRACT

Disclosed is a multi-core processor, and more particularly, a method of optimizing performance of a multi-core processor having a hierarchical structure and a multi-core processor system for performing the method. To this end, the method of optimizing performance of a hierarchical multi-core processor including a plurality of kernel cores, each kernel core including a plurality of cores sharing a memory, the method includes calculating a correlation between a plurality of threads by a thread correlation managing module within a main processor; grouping the plurality of threads into two or more threads according to information on the calculated correlation by the main processor; and allocating each of the grouped threads within an equal group to each core within an equal kernel core of the hierarchical multi-core processor by a scheduler of the main processor.

### CROSS-REFERENCE TO RELATED APPLICATIONS

This application is based on and claims priority from Korean Patent Application No. 10-2012-0015291, filed on Feb. 15, 2012, with the Korean Intellectual Property Office, the disclosure of which is incorporated herein in its entirety by reference.

### TECHNICAL FIELD

The present disclosure relates to a multi-core processor, and more particularly, to a method of optimizing performance of a multi-core processor having a hierarchical structure and a multi-core processor system for performing the method.

### BACKGROUND

According to a current demand for high performance of mobile devices, the necessity for a multi-core processor has increased.

The multi-core processor refers to a processor having two or more cores. In a case of a conventional single-core processor, performance of the processor has been improved by increasing a clock rate of the processor, but there is a disadvantage of huge power consumption and a heat generation problem when the clock rate is increased. Accordingly, in order to improve the above mentioned problems, a multi-core processor technology capable of operating at a relatively low frequency and distributing power consumption to several cores has been developed.

Meanwhile, when the multi-core processor is used, dynamic power consumption can be reduced in comparison with the single-core processor, but a battery technology cannot keep up with an improvement on the processor's performance, so it is still an important issue that a mobile device or an embedded system using limited power provides a stable driving time to a user through reduced power consumption.

The multi-core system includes a symmetric multi-processing (SMP) system having a plurality of equal cores and an asymmetric multi-processing system including various heterogeneous cores such as a digital signal processor, a graphic processing unit (GPU) or the like.

FIG. 1 is a diagram illustrating a hierarchical multi-core processor based on a kernel core having a shared memory or a cache.

Referring to FIG. 1, a hierarchical multi-core processor includes a plurality of kernel cores 100, and the plurality of kernel cores 100 communicate with each other through a high speed network on chip (NoC) 103. Each kernel core 100 includes a plurality of cores 101, and the plurality of cores 101 share and use a cache or a shared memory 102.

In this case, the symmetric multi-processing system may have a hierarchical multi-core structure in a form of grouping the plurality of cores 101 sharing the memory 102 into one kernel core 100 and expanding the kernel core 100 to a plurality of kernel cores for a performance improvement and expandability of the multi-core as shown in FIG. 1. Accordingly, the cores 101 within the kernel core 100 share the cache or the shared memory 102, and the kernel cores 100 communicate with each other through the high speed network on chip 103, so that it is possible to increase expandability while reducing performance deterioration due to a memory access according to the memory sharing of the plurality of cores.

In order to enable several cores to execute applications for processing a lot of data in parallel so as to improve the performance, all data which should be processed is divided, the divided data is allocated to each core, and each core should process the data.

As a method for the performance improvement, there is a static scheduling method of dividing data to be processed into the number of data corresponding to the number of cores and then dividing operations. Even though sizes of the divided data are the same, times when the cores terminate the operations are different due to effects of an operating system, a multi-core S/W platform, and another application, so that performance deterioration may be generated. In this case, a dynamic scheduling method in which a core which has terminated all operations allocated to the core gets and performs some of the operations allocated to another core can be used.

Meanwhile, when threads are simply sequentially allocated in the multi-core processor system having the hierarchical structure without considering the operation divided according to the scheduling method in the related art, that is, without considering a correlation between the threads, a delay time due to data transmission between the cores is increased, and thus the performance of the multi-core processor is significantly deteriorated.

### SUMMARY

The present disclosure has been made in an effort to provide a method of optimizing performance of a hierarchical multi-core processor and a multi-core processor system for performing the method capable of optimizing the performance of the multi-core processor and accordingly minimizing static power consumption by minimizing a time delay due to data communication between cores by preferentially allocating threads having a high correlation in the hierarchical multi-core processor based on a kernel core having a shared cache or a shared memory to a core within the same kernel.

An exemplary embodiment of the present disclosure provides a method of optimizing performance of a hierarchical multi-core processor including a plurality of kernel cores, each kernel core including a plurality of cores sharing a memory, the method including: calculating a correlation between a plurality of threads by a thread correlation managing module within a main processor; grouping the plurality of threads into two or more threads according to information on the calculated correlation by the main processor; and allocating each of the grouped threads within an equal group to each core within an equal kernel core of the hierarchical multi-core processor by a scheduler of the main processor.

Another exemplary embodiment of the present disclosure provides a multi-core processor system including: a hierarchical multi-core processor including a plurality of kernel cores, each kernel core including a plurality of cores sharing a memory; and a main processor configured to allocate each thread to each of the cores, wherein the main processor calculates a correlation between a plurality of threads, groups the plurality of threads into two or more threads according to information on the calculated correlation, and allocates each of the grouped threads within an equal group to each core within an equal kernel core of the hierarchical multi-core processor.

According to the exemplary embodiments of the present disclosure, a method of optimizing performance of a hierarchical multi-core processor can optimize the performance of the multi-core processor by minimizing a delay in data communication between cores by preferentially allocating threads having a high correlation therebetween to cores within a kernel core sharing a memory when the multi-core processor having a hierarchical structure processes applications in parallel.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a diagram illustrating a hierarchical multi-core processor based on a kernel core having a shared memory or a cache.

FIG. 2 is a diagram illustrating a multi-core processor system having a hierarchical structure according to an exemplary embodiment of the present disclosure.

FIG. 3 is a diagram illustrating a thread allocation considering a correlation in a hierarchical multi-core processor system according to an exemplary embodiment of the present disclosure.

FIG. 4 is a flowchart illustrating a performance optimization procedure in a hierarchical multi-core processor according to an exemplary embodiment of the present disclosure.

### DETAILED DESCRIPTION

In the following detailed description, reference is made to the accompanying drawing, which form a part hereof. The illustrative embodiments described in the detailed description, drawing, and claims are not meant to be limiting. Other embodiments may be utilized, and other changes may be made, without departing from the spirit or scope of the subject matter presented here.

The present disclosure properly allocates threads to cores in consideration of a correlation characteristic between the threads in order to improve a thread allocation method unsuitable for a multi-core processor having a hierarchical structure in the related art and maximize performance of the multi-core processor, so that it is possible to minimize a time delay due to communication between the cores and optimize the performance of the multi-core processor.

Meanwhile, a thread refers to one execution unit which is a control flow within a predetermined program, particularly within a process. In general, one program has one thread, but can simultaneously execute two or more threads according to a program environment, which is called a multi-thread.

Hereinafter, exemplary embodiments according to the present disclosure will be described in detail with reference to the accompanying drawings. Configurations of the present disclosure and their operation effects are clearly understood through the following description.

Before undertaking the detailed description, it is noted that like reference numerals refer to like elements although indicated in different drawings and a detailed description of well-known functions and configurations making the subject matter of the present disclosure unclear will be omitted.

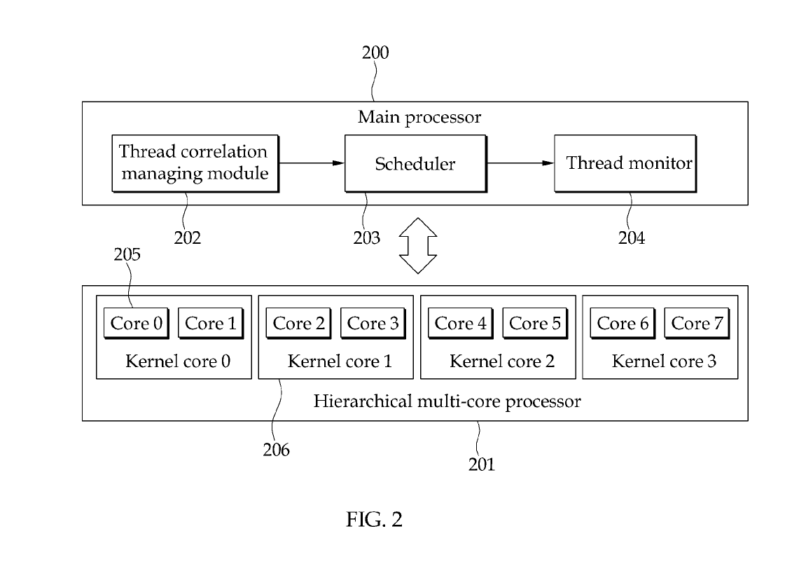

FIG. 2 is a diagram illustrating a multi-core processor system having a hierarchical structure according to an exemplary embodiment of the present disclosure.

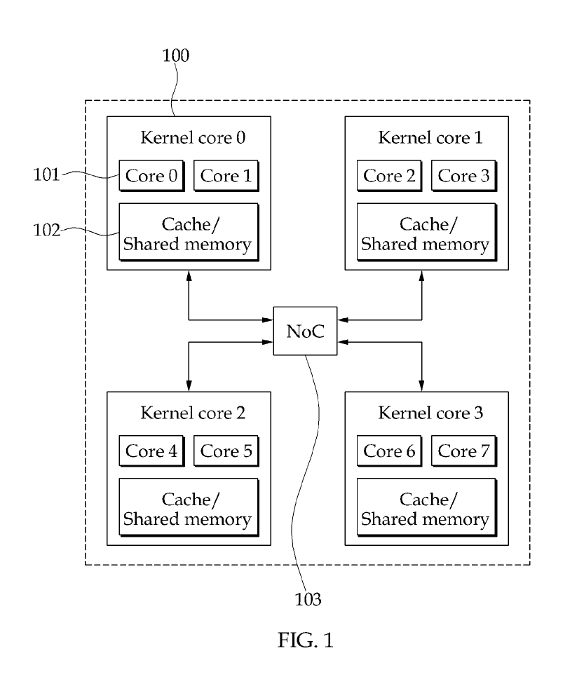

Referring to FIG. 2, a multi-core processor having a hierarchical structure according to an exemplary embodiment of the present disclosure may include a main processor 200 and a hierarchical multi-core processor 201. The main processor 200 may include a thread correlation managing module 202, a scheduler 203, a thread monitor 204 and the like. Meanwhile, the hierarchical multi-core processor 201 has a structure simplified from a structure of the hierarchical multi-core processor of FIG. 1, and detailed components such as the cache/shared memory, the NoC and the like are omitted in FIG. 2.

Meanwhile, the main processor 201 additionally configured according to the exemplary embodiment of the present disclosure performs a function of allocating threads to each core based on a correlation between the hierarchical multi-core processor 201 and the thread.

In this case, the hierarchical multi-core processor 201 includes a plurality of kernel cores 206 having the shared memory or the shared cache as described above, and the kernel core 206 may include a set of two or more cores sharing the memory or the cache.

The main processor 200 for allocating the thread to each core may include the thread correlation managing module 202 for storing correlation information obtained by calculating a correlation between threads according to the exemplary embodiment of the present disclosure, the thread monitor 204 for periodically monitoring a state of the thread allocated to each core and the scheduler 203 for allocating each thread to the core based on thread correlation information.

The thread correlation managing module 202 may store and manage a value preset by the user based on a subordinate relationship between threads, a degree of memory sharing and the like, or may be implemented in a form of a module for performing a calculation through a process according to a separate equation.

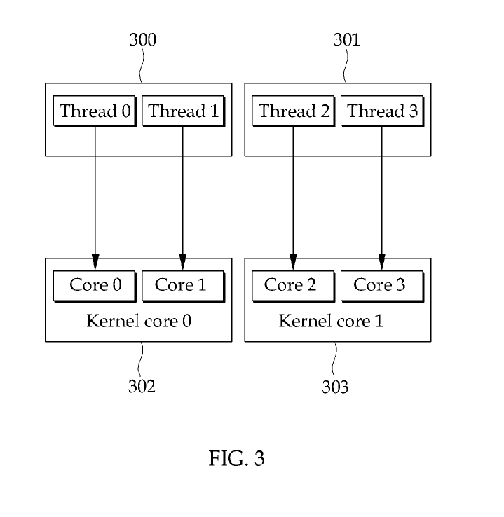

FIG. 3 is a diagram illustrating a thread allocation considering a correlation in a hierarchical multi-core processor system according to an exemplary embodiment of the present disclosure.

Referring to FIG. 3, a thread allocation method according to an exemplary embodiment of the present disclosure includes tying threads having the highest correlation therebetween into thread pairs 300 and 301, and grouping to be combinations of {thread 0, thread 1}, {thread 2, thread 3}, . . . based on the correlation information between the threads as shown in FIG. 3. The tied threads included in the same group are allocated to cores within the same kernel core 302 or 303, respectively.

For example, since thread 0 and thread 1 have a high correlation therebetween according to information on the calculated correlation, thread 0 and thread 1 are allocated to the same kernel core #0 302. Similarly, since thread 2 and thread 3 have a high correlation therebetween according to information on the calculated correlation, thread 2 and thread 3 are allocated to the same kernel core #2 303.

Meanwhile, since the threads allocated to the same kernel cores 302 and 303 have high correlations therebetween, there is a subordinate relationship between respective threads, and (or) the threads frequently access shared data. Accordingly, it is possible to quickly transmit data while the threads share the memory or the cache within the same kernel core.

Accordingly, it is possible to definitely reduce a delay according to data communication between cores in comparison with a method in the related art of sequentially allocating threads to cores regardless of a correlation between the threads.

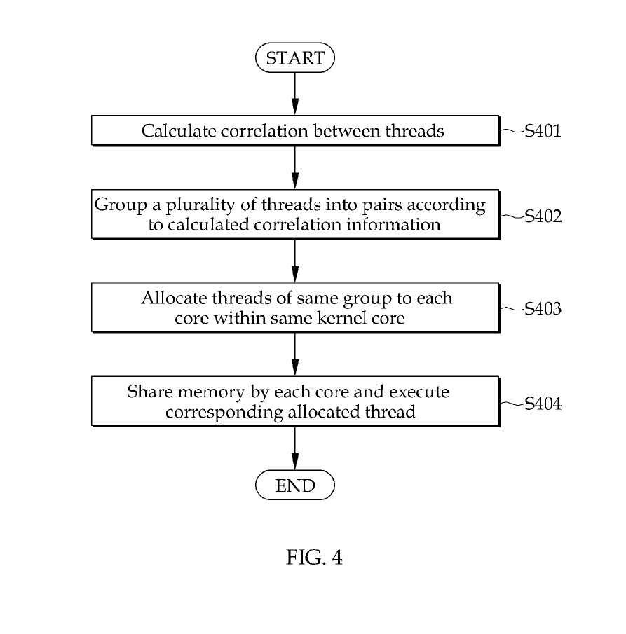

FIG. 4 is a flowchart illustrating a performance optimization procedure in a hierarchical multi-core processor according to an exemplary embodiment of the present disclosure.

Referring to FIG. 4, correlations between a plurality of threads are first calculated in step S401. Then, two threads are tied into a pair or three or more threads are grouped into one group according to information on the calculated correlation in step S402. As described above, when the threads are grouped according to an exemplary embodiment of the present disclosure, the threads of the same group are allocated to each core within the same kernel core in step S403.

Finally, each core processes corresponding threads allocated by sharing a memory (for example, cache/shared memory) in step S404.

As described above, the threads having the high correlation therebetween are allocated to the cores within the same kernel core based on correlation information between the threads according to an exemplary embodiment of the present disclosure, so that the threads can share the memory or the cache. As a result, a delay time spent on data transmission between cores is greatly reduced, and thus performance of the multi-core processor having the hierarchical structure can be significantly improved.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

What is claimed is:

1. A method of optimizing performance of a hierarchical multi-core processor comprising a plurality of kernel cores, each kernel core comprising a plurality of cores sharing a memory, the method comprising:
calculating a correlation between a plurality of threads by a thread correlation managing module within a main processor;
grouping the plurality of threads into two or more threads according to information on the calculated correlation by the main processor; and
allocating each of the grouped threads within an equal group to each core within an equal kernel core of the hierarchical multi-core processor by a scheduler of the main processor.

2. The method of claim 1, wherein the plurality of kernel cores within the hierarchical multi-core processor communicate with each other through a network on chip.

3. The method of claim 1, wherein the correlation between the plurality of threads is stored as a preset value and the preset value is used.

4. The method of claim 3, wherein the correlation is preset based on a subordinate relationship between the plurality of threads.

5. The method of claim 3, wherein the correlation is preset based on a degree of memory sharing between the plurality of threads.

6. A hierarchical multi-core processor system comprising:
a hierarchical multi-core processor comprising a plurality of kernel cores, each kernel core comprising a plurality of cores sharing a memory; and
a main processor configured to allocate each thread to each of the cores,
wherein the main processor calculates a correlation between a plurality of threads, groups the plurality of threads into two or more threads according to information on the calculated correlation, and allocates each of the grouped threads within an equal group to each core within an equal kernel core of the hierarchical multi-core processor.

7. The hierarchical multi-core processor system of claim of 6, wherein the kernel core comprises a cache or a shared memory in which the plurality of cores share data.

8. The hierarchical multi-core processor system of claim of 6, wherein the hierarchical multi-core processor further comprises a network on chip for providing mutual communication between the plurality of kernel cores.

9. The hierarchical multi-core processor system of claim of 6, wherein the correlation between the plurality of threads is stored as a preset value and the preset value is used.

10. The hierarchical multi-core processor system of claim of 9, wherein the correlation is preset based on a subordinate relationship between the plurality of threads.

11. The hierarchical multi-core processor system of claim of 9, wherein the correlation is preset based on a degree of memory sharing between the plurality of threads.
